(19) United States
(12) Patent Application Publication
(10) Pub. No.: US 2009/0055825 A1
(43) Pub. Date: Feb. 26, 2009

(54) WORKFLOW ENGINE SYSTEM AND METHOD

(76) Inventors: Gary S. Smith, Castle Rock, CO (US); Joseph P. White, Castle Rock, CO (US)

Correspondence Address: SHUGHART THOMSON & KILROY, PC, 120 WEST 12TH STREET, KANSAS CITY, MO, 64105, US

(21) Appl. No.: 11/841,311

(22) Filed: Aug. 20, 2007

(51) Int. Cl. G06F 9/48

(52) U.S. Cl. 718/102

(57) ABSTRACT

Provided is a workflow engine for managing data. More specifically, the workflow engine includes a receiving subsystem that is operable to receive data. An environment evaluating subsystem is also provided and is operable to evaluate an environment and determine at least one environmental parameter. A data evaluating system is in communication with the receiving subsystem and the environment evaluating subsystem. The data evaluating system is operable to determine at least one data parameter from the received data and to receive the environmental parameter. The data evaluating system will evaluate the data parameter and environment parameter and select at least one appropriate workflow rule for use in establishing a workflow job operation for execution by a job operation subsystem. An associated method of use is also provided.

### FIELD

This invention relates generally to the field of automated decision management, and in particular to data driven workflow engine for managing complex decision logic.

### BACKGROUND

The complexity and control of systems is an ever increasing issue. In many situations, the complex logic is hard coded within an algorithm or execution thread within a system. This hard coding makes the logic less than easily adaptable to changing situations and environments. In many mission scenarios it is possible to anticipate events that might occur and reactions that might be taken. Just the same, it is also realized that the appropriate action for one event in one environment may be inappropriate for the same sort of event in a different event.

The process of evaluating each and every event and situation uniquely is likely to be quite cumbersome, and may well retard the decision making process for an effective response. Such a delay may be costly both in terms of resources as well as opportunity, and in some cases may even put human lives at risk.

At the same time in a large system it is not uncommon for there to be many different aspects that are widely desired by a variety of different users utilizing a variety of different hardware and software systems. The differences between the systems can and often do impose yet another burden upon the user, as he or she must know in advance how to bridge different systems. Often times this bridging is not a task easily accomplished in real time, but rather is something that requires pre-configuration.

For example, and only in a very general sense, a Unix network may support a repository of data files which a Windows platform user may wish to suddenly access in a quest to resolve a resource availability question in the determination of a scheduling event (such as the location of a satellite at a specific time over a geographic area). Samba is a well known file accessing system that permits Windows platform systems to exchange data with Unix/Lynx systems, but the Samba application must be pre-existing and configured on the Unix/Lynx system before such a connection can be made.

Further, in large scale mission situations, multiple operation may be occurring in multiple environments simultaneously or nearly simultaneously. Customizing a decision making process or system for each plausible environment is far from an ideal solution. Such customization may also result in single application systems which can not be recycled in future missions that are not identical.

Hence, there is a need for a workflow engine to support a mission management system that overcomes one or more of technical problems noted above.

### SUMMARY

This invention provides a system and method for a workflow engine for managing data.

In particular, and by way of example only, according to one embodiment of the present invention, provided is a workflow engine for managing data, comprising: a receiving subsystem operable to receive data; an environment evaluating subsystem operable to evaluate an environment and determine at least one environmental parameter; a data evaluating subsystem in communication with the receiving subsystem and the environment evaluating subsystem, the data evaluating subsystem operable to; receive data from the receiving system and determine at least one data parameter; receive the at least one environmental parameter; evaluate the data parameter and environmental parameter and determine the selection of at least one appropriate workflow rule; and establish a workflow job operation for execution by a job operation subsystem.

In at least one alternative embodiment, provided is a workflow engine for managing data, comprising: an interface operable to provide connectivity between the workflow engine and an external enterprise; a translation subsystem coupled to the interface, translation subsystem operable to translate inbound data from an enterprise format to a compliant workflow engine format and to translate outbound data from the compliant workflow engine format to an enterprise format; an environment evaluating subsystem operable to evaluate an environment and determine at least one environmental parameter; a workflow rule pool having at least one workflow rule; a data evaluating subsystem in communication with the translation subsystem, the environment evaluating subsystem and the workflow rule pool, the data evaluating subsystem operable to; receive data from the interface and determine at least one data parameter; receive the at least one environmental parameter; evaluate the data parameter and environmental parameter to determine the selection of at least one appropriate workflow rule from the workflow rule pool; and establish a workflow job operation for execution by a job operation subsystem.

In yet another embodiment, provided is a method of adaptive mission management, comprising: receiving data in enterprise format; translating the received data into a workflow engine format; sampling the environment to determine at least one environmental parameter evaluating the translated data to determine at least one data parameter; evaluating the data parameter and the environmental parameter to identify at least one appropriate workflow rule; selecting at least one identified workflow rule and developing a workflow job operation with respect to the selected rule, translated data and environmental parameter; and directing the workflow job operation to a job operation subsystem for execution.

### BRIEF DESCRIPTION OF THE DRAWINGS

FIG. 1 illustrates a conceptual block diagram of a workflow engine in an enterprise environment according to at least one embodiment;

FIG. 2 is a flow diagram illustrating at least one method of operating the workflow engine of FIG. 1 in accordance with at least one embodiment;

FIG. 3 is a block diagram illustrating a plurality of instantiated workflow engines in a system and various workflow rules as may be provided in at least one embodiment, and

FIG. 4 is a block diagram of a computer system in accordance with one or more embodiments.

### DETAILED DESCRIPTION

Before proceeding with the detailed description, it is to be appreciated that the present teaching is by way of example only, not by limitation. The concepts herein are not limited to use or application with a specific type of problem solving system. Thus, although the instrumentalities described herein are for the convenience of explanation, shown and described with respect to exemplary embodiments, it will be appreciated that the principles herein may be applied equally in other types of problem solving systems.

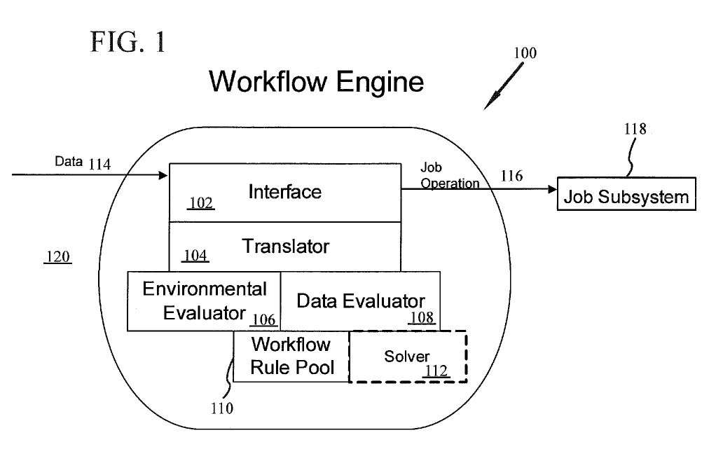

FIG. 1 is a high level conceptual diagram of the workflow engine 100 in accordance with at least one embodiment. Workflow engine 100 may be implemented on a computer having typical computer components, such as a processor, memory, storage devices, and input and output devices. During operation, workflow engine 100 may be maintained in active memory for enhanced speed an deficiency. In addition in at least one embodiment, workflow engine 100 is operated on a computer network and utilizes distributed resources.

With respect to FIG. 1, in at least one embodiment workflow engine 100 includes an interface 102, a translator 104, an environment evaluator 106, a data evaluator 108 and a workflow rule pool 110. In at least one alternative embodiment, the workflow engine 100 also has a solver 112.

As indicated, workflow engine 100 receives data 114 from the enterprise in which it is instantiated, and, in response to this received data is operable to provide a job operation 116 when appropriate. As indicated by FIG. 1, the job operation 116 is provided to a job operation subsystem 118 that is not typically an integrated element of workflow engine 100. The job operation subsystem 118 may of course have a job pool to receive job operations and hold them till execution is possible.

In at least one embodiment, such as where workflow engine 100 is instantiated in a computer setting, the interface 102 is provided by an interface routine, the translator 104 by a translation routine, the environment evaluator 106 by an environment evaluator routine, the data evaluator 108 by a data evaluator routine, the workflow rule pool 110 by a workflow rule pool routine, and when provided, the solver 112 by a solver routine. It is of course understood and appreciated that each routine may include sub-routines or other sub-components.

Briefly stated, the interface 102 is operable to receive data. The environment evaluator 106 is operable to evaluate an environment 120 and determine at least one environmental parameter. The data evaluator 108 is in communication with the interface 102 and the environment evaluator 106. The data evaluator 108 is operable to receive data from the interface and determine at least one data parameter, and receive the at least one environmental parameter from the environment evaluator 106. The data evaluator evaluates the data parameter and the environmental parameter and determines the selection of at least one appropriate workflow rule. The selected workflow rule is used to establish a workflow job operation that is provided for execution to the job operation subsystem 118.

More specifically, the interface 102 is responsible for providing connectivity to the external enterprise in which the workflow engine 100 is instantiated. More specifically, the enterprise is understood and appreciated to be any element that is not a component of the workflow engine 100. The interface 102 accepts messages from other entities, and is also responsible for providing outgoing traffic from the workflow engine 100 back to the enterprise. The interface 102 permits the workflow engine 100 to remain agnostic to the type of system in which it is deployed. More specifically, by abstracting the enterprise communication structure, the rest of the workflow engine 100 is able to remain advantageously portable and agile in the face of new, different or changing communication paradigms.

This ability to adaptively handle interaction with the enterprise is chiefly assisted by the translator 104. The translator 104 is operable to take received data, e.g., messages to the workflow engine 100 from the enterprise, and translate them to a format compliant for internal processing. The translator 104 is also responsible for converting internal workflow objects into the enterprise data format. In at least one embodiment the workflow engine format is defined to be that of the Extensible Markup Language, otherwise known as XML. XML provides a text-based means to describe and apply a three-based structure to information. XML code is understood and appreciated to consist of elements and attributes, and of course nested elements.

Through the structured format, XML permits workflow engine 100 to have a pre-defined format for internal data operations. Indeed, by standardizing the input provided through the interface 102 to the translator 104 into XML, workflow engine 100 is free to operate without additional overhead complexity. Moreover, the workflow engine 100 is operable to assist a wide variety of users in a wide variety of systems and platforms.

Moreover, the translator 104 permits the workflow engine 100 to communicate in the language of an external party that is required to send data to, or receive data from the workflow engine 100. By abstracting the external messaging structure from the core decision logic, the workflow engine is advantageously functional in a diverse set of circumstances and systems.

In at least one embodiment the translator is provided by a combination of XMLBeans and XSLT. XMLBeans is understood and appreciated to convert Java objects into XML representations. XSLT is used to translate one ML message/documents into another XML message/document. In combination SMLBeans and XSLT provide a translator 104 operable to provide a translation at the message level (XSLT) and provide an efficient means to evolve the underlying workflow system object (SMLBeans) to meet the needs of different enterprise systems.

Once the translation has been completed, the incoming data, now in a compliant format, is delivered directly to the data evaluator 108. Given translated data, the data evaluator 108 is responsible for building the relationships between an identified task and defining any triggered processing that is to take place. The type of processing that may take place is dependent on the time of data that is provided, both by the enterprise via the interface and translator which collectively operate as a receiving subsystem, and the environment evaluator 106.

As used herein, the environment is understood and appreciated to be the internal and external state of the node supporting the workflow engine 100 and physical area proximate to that node. More specifically, the environment information includes state information such as, but not limited to, physical location, velocity, acceleration, altitude, attitude, orbit, weather, location of friendly forces and resources, location of foreign forces and resources, current system memory and resource state, etc. . . .

As the state of the world in which the workflow engine 100 is operating changes, and is noted by the environment evaluator 106, the workflow engine can and will adapt the type of processing that takes place given a particular task. Moreover, this ability to evaluate the environment and adaptively change the task and/or data processing provides the workflow engine with its advantageous adaptive ability.

It is the environment evaluator 106 that operates to provide the data evaluator 108 with an evaluation of the state of the world. By consuming data from the rest of the enterprise and evaluating the relationships between the provided data and the evaluated environment the data evaluator 108 is able to modify determined workflows to meet the demands of a changing world environment.

Moreover, identical instances of workflow engine 100 may be deployed as different nodes in an over all system, such as in ground vehicles, aircraft, satellites, etc. . . . , yet each workflow engine 100 within the system will process information and determine appropriate job operation tasks based on the state of the world from the perspective of where the workflow engine 100 is within the system. When provided as a computer code or a computer system, this advantageously permits the same set of code to be deployed on all systems in an enterprise, yet each deployed instance will exhibit different behavior at each individual node of deployment.

This adaptable behavior is facilitated by the existence of the workflow rule pool 110 that is in communication with the data evaluator 108. The workflow rule pool 110 provides at least one, and more preferably a plurality of pre-defined rules for the generation of a workflow job operation task. In at least one embodiment each workflow rule is defined as an XML object and the workflow rule pool is maintained as an XML table.

In general, the workflow rules are established in an “If-Then-Else” structure. In other words, the structure of a first rule could be described as, “if the data parameter is X and the environment parameter is Y, then the task to perform is A.” The structure of a second rule could be, “if the data parameter is X and the environment parameter is Z, then the task to perform is B.”

It is further understood and appreciated that in at least one embodiment, the data evaluator 108 is operable to determine provided data received through the interface as rule data, and an indication as to whether the rule data indicates a new rule to add to the pool or a rule to remove from the pool. In at least one embodiment, the update of a pre-existing rule is processed as both a deletion (of the old rule) and an addition (of the new rule).

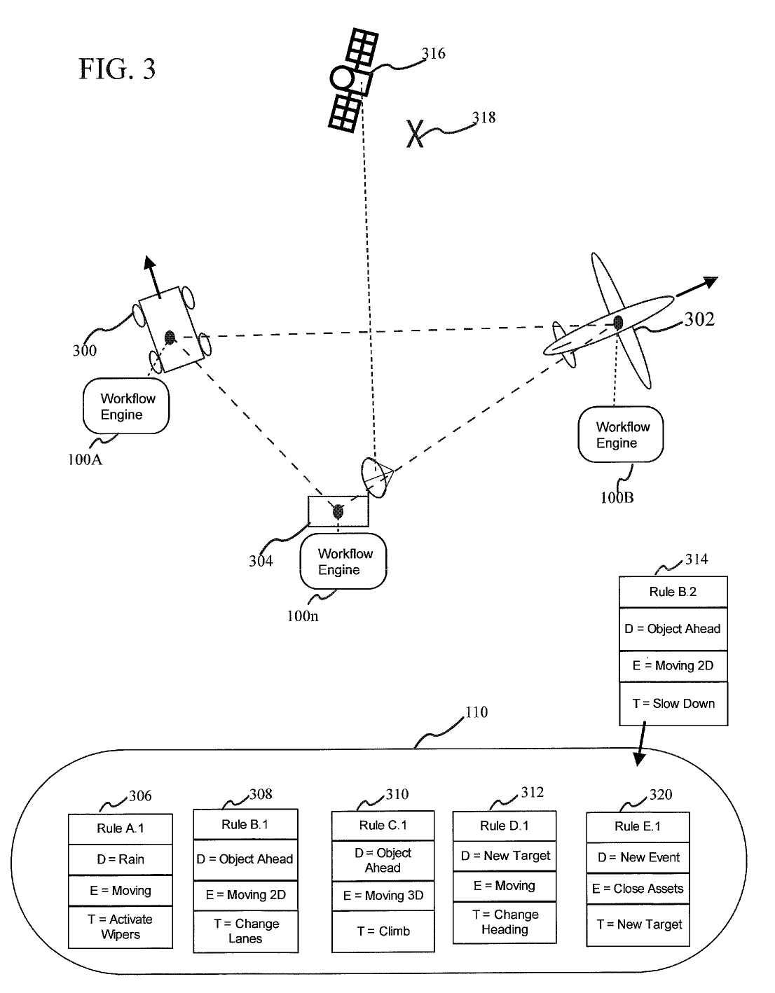

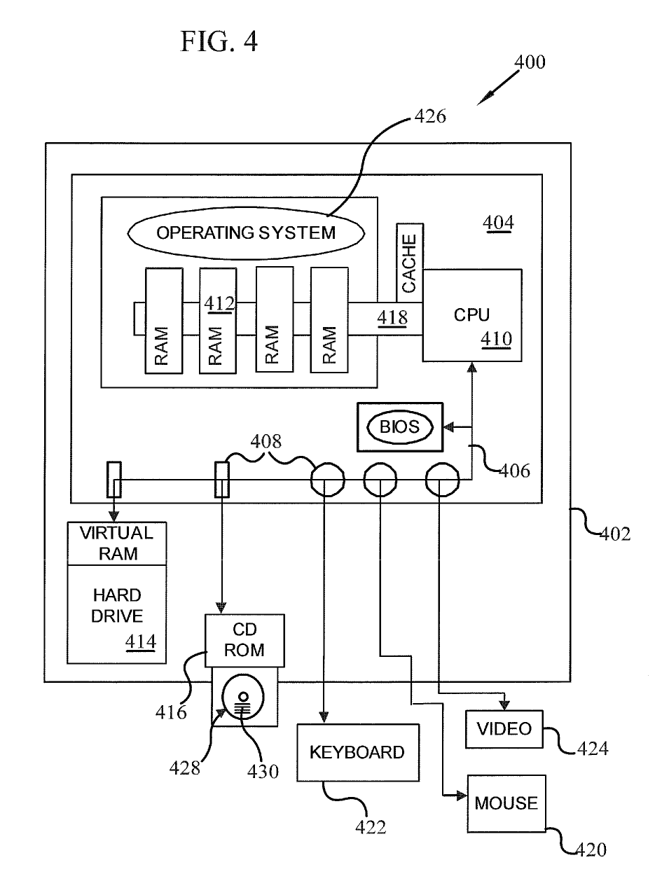

The process and operation of the workflow engine 100 in accordance with at least one embodiment will now further be described with respect to the flow diagram of FIG. 3 and conceptual block diagram of FIG. 4. It is further understood and appreciated that the steps as they are herein described are not necessarily required to be performed in the order as herein described, but that this ordering is exemplary of at least one embodiment and has been selected to facilitate the ease of discussion and illustration.

The components of the workflow engine 100, e.g., interface 102, translator 104, environment evaluator 106, data evaluator 108, workflow rule pool 110 and solver 112, share communication and availability status with the other components to which they are directly connected. When a component initializes, it uses a handshaking mechanism to determine the status of its connections. In at least one embodiment, the communication protocol between components is automatically determined and dispositioned accordingly: object-to-object communication for components within a single process space, versus messaging for network distributed components. Communication between the components in the problem solving system may be either synchronous or asynchronous.

It should be understood and appreciated that in at least one embodiment these elements of the workflow engine 100 may be physically and/or geographically separated from one another, though in direct communication so as to function as a unified whole system. In at least one alternative embodiment, these elements of the workflow engine 100 are all present within the same system node, the environment evaluator 106 of course having at least one sensor pathway to detect environmental data and determine at least one environmental parameter.

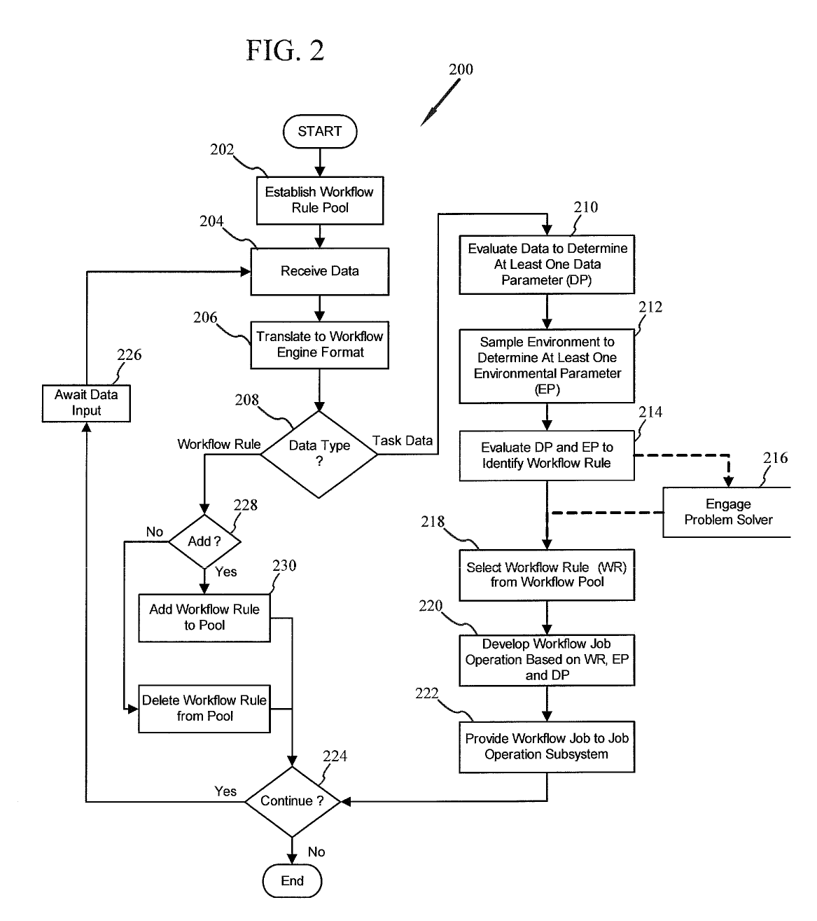

With respect to FIG. 2, upon commencement of operation of workflow engine 100 upon a node, the workflow engine 100 proceeds instantiates as a workflow engine method 200, with the first step in at least one embodiment being to establish a workflow rule pool, block 202. As indicated above, in at least one embodiment the workflow rules are defined in XML, such that each may be handled as an XML object and tracked as a member of the workflow rule pool by an XML table.

With the workflow rule pool 110 established, the workflow engine 100 is initialized and set to receive data from the enterprise. This data may be provided by a human user or an automated system, such as for example; radar, heat sensor, motion sensor, moisture sensor, timer initiated event, etc. . . . It should be understood and appreciated that the environment evaluator 106 may in actuality have sensors connected to the same sorts of automated systems.

Upon the receipt of data by the interface 102, block 202, the data is inspected to determine the appropriate translator to be retrieved and applied to the incoming data so as to convert the data to the internal format workflow engine 100. When instantiated as an operable system within a computer environment a variety of translators are preferably provided as translator objects, again defined in XML. Of course, if the data is already in a compliant format, no translation is required before the data is provided to the data evaluator 108.

With an appropriate translator determined and selected, the incoming data is translated into workflow engine format, block 204. The evaluation of the data and selection of the appropriate translator may be performed by the interface, or in the alternative by the translator 104. In an alternative embodiment, the workflow engine may also provide a manager that operates to track and direct the flow of data and communication within the workflow engine 100. In at least one embodiment this manager is provided as a general table and the addition of metadata attached to the received data.

FIG. 3 presents a conceptualization of workflow engine 100 deployed in several instances, the first being in a land vehicle 300, workflow engine 100A, the second in an aircraft 302, workflow engine 100B, and an n'th being a base facility 304, workflow engine 100n. Each instance of workflow engine 100A, 100B, 100n is operable entirely within its own environment, that of the land vehicle 300 and its surroundings, that of the aircraft and its surroundings and that of the base 304 and its surroundings. Further, in at least one embodiment, the workflow engines 100A, 100B, 100n are in communication with each other.

Also illustrated in FIG. 3 are a set of rules. Specifically, Rule 306 is Rule A.1, defined to state that if data parameter D=Rain, and the environmental parameter E=Moving, then the task T is active wipers. Rule 308 is Rule B.1 defined to state that if data parameter D=Vehicle Ahead, and the environmental parameter E=Moving with respect to two dimensions (i.e., as in on a road), then the task T is change lanes. Rule 310 is Rule C.1 defined to state that if data parameter D=Rain, and the environmental parameter E=Moving in three dimensions (i.e., flying) then the task T is climb. Rule 312 is D.1 defined to state that if data parameter D=New Target, and the environmental parameter E=Moving, then the task T is change heading to New Target. Initially, for the sake of example it is assumed that these rules are the initial rules populating the workflow rule pool 110.

Although illustrated as a single workflow rule pool 110, in at least one embodiment, each instance of workflow engine 100 has its own workflow rule pool 110. Although in varying embodiment, one or more instances of workflow engine 100 may share a common workflow rule pool, in many instances it is preferable for each instance to have its own copy of the workflow rule pool so as to expedite operations in situations where connectivity to remote resources is taxed.

In a first instance, the land vehicle 300 is traveling along a road. Returning to FIG. 2, the incoming data is received by workflow 100A of the land vehicle, in block 204, and translated to the workflow engine format, in block 206. The data is then evaluated to determine if it is data relevant to the addition or removal of a workflow rule, or data relevant to a task requiring the development of a workflow job, decision 208.

In the current example, the data does not indicate itself to be workflow rule related. As such the data evaluator 108 evaluates the data and determines at least one data parameter, block 210. In this first example, the data parameter (DP) is the indication that there is a vehicle directly in front of the land vehicle 300. The data evaluator then obtains at least one environment parameter (EP) from the environment evaluator 106, block 212. For this example, the at least one environment parameter is that the land vehicle is in motion, and the motion is two dimensional travel along a road.

The data evaluator 108 now acts to select an appropriate rule based on the data parameter (DP) and environment parameter (EP) to identify an appropriate workflow rule, block 214. With respect to the initial example rules, rule 308 is Rule B.1 and pertains to a vehicle moving in two dimensions and there being an object ahead. Rule 310 is Rule C.1 and also pertains to a vehicle moving and an object ahead, however, rule C.1 involves movement in three dimensions rather than two, and is therefore not applicable.

Rule 308 is selected from the workflow rule pool 110 and used to develop a workflow job, block 220. It is noted that the workflow engine 100 is not the entity that performs the workflow job. Rather, workflow engine 100 is the entity that assembles workflow job as a task for execution by other systems or a human operator. As such the workflow job is provided to the job operation subsystem for execution, block 222.

It is understood and appreciated that a task may indeed comprise a number of subtasks. More specifically, the selected workflow rule may involve a plurality of sub rules, at least a subset of which must be applied to develop a viable workflow job operation. Indeed, just as the rule may in actuality be a meta-rule, composed of a plurality of sub-rules, the task may be a meta-task, being comprised of a plurality of sub-tasks.

As indicated above, in at least one embodiment, the preferred data format within the workflow engine 100 is XML. As XML is understood and appreciated to provide support for nested elements, the formation of a meta-rule having nested sub-rule elements and the development of a meta-task having nested tasks is quite easily supported and does not impose a burden of complexity upon workflow engine 100.

With the workflow job then provided to the Job Operation subsystem, block 222, the workflow engine may query to see if continued operation is desired, decision 224, and in the affirmative, returns to a sate of awaiting user input, block 226.

Whereas the above example is applicable for the land vehicle 300, in a similar example workflow engine 100B of the aircraft 302 may receive data indicating an object ahead as well. Following through the above steps of determining at least one data parameter (DP) and an environmental parameter (EP), blocks 210 and 212, in this case the identified rule will be rule 310 Rule C.1 as the aircraft is moving in three-dimensions.

Moreover, it is appreciated that although workflow engine 100A is identical to workflow engine 100B, each is disposed in a different environment and therefore operating to determine different appropriate tasks. Of course, it is also possible for each workflow engine 100A and 100B to determine the same task from the same selected rule, such as for example rule 304 as Rule A.1, which in response to the DP being “rain,” and the EP being “moving,” will result in the task for the workflow job being to engage the wipers on the windshield.

In yet another example, rule 314 as Rule B.2 is provided to the workflow engine 100. Indeed the rule may be provided throughout the system so as to be received by all instances of workflow engine 100 (e.g., 100A, 100B, . . . 100n), or it may be directed to a specific instance of a workflow engine, i.e., workflow engine 100A. In this instance, the data is recognized to regard a workflow rule, decision 208. In at least one embodiment, the operations that may be performed are either to add a rule or delete a rule. To update a known rule source, it is appreciated that both a delete (to remove the old data source) and an add (to add the new data source) may be performed. More specifically, the user data is queried block 228, to determine if directive is to add or delete, blocks 230 and 332, respectively.

For this example the data is evaluated to understand the directive as being to add Rule B.2 to the data pool. In this example it is appreciated that Rule B.2 is a new version of the previously known Rule B.1. In this embodiment, the workflow engine will look to the latest version of a rule when evaluating a rule for selection. In at least one embodiment, version tracking is incorporated in this manner to insure that pre-existing workflow jobs that have been developed in response to previous rules are executed in accordance with the tasks as directed at the time of development. The new rule then will direct subsequent workflow job development for the new and different task.

For example, after integration of rule 310 into the workflow rule pool 110, workflow engine 100A of the land vehicle 300 receives data having a data parameter indicating an object directly ahead. In this instance the determination of the DP and EP will again lead to the selection of a rule, blocks 212, 214 and 216. However, in this round the new Rule B.2 will take precedence over the former Rule B.1, and the developed workflow job operation based on the WR, EP and DP will be to slow down to match speed rather than to change lanes.

In yet another example, the base 304 may be in communication and control over an orbiting satellite 316. From the satellite 316 the base 304 may become aware of a new event 318, such as a natural disaster, terrorist activity, or parties in distress. In this case, the base 304 workflow engine 100n may receive from the environment evaluator 106 environmental parameters (EP) that indicate that land vehicle 300 and aircraft 304 are the closest assets to the new event. Moreover, it is understood and appreciated that the workflow engine 100, and more specifically the environment evaluator 106 can utilize resources and assets that are otherwise already in use or connected to a supporting node system.

This data information may trigger rule 320 as Rule E.1 which directs a data communication to the land vehicle 300 and aircraft 304, and more specifically to the workflow engines 100A, 100B which upon receipt will trigger each workflow engine to select rule 312 and adopt a new heading towards the newly identified event 318.

It is to be realized and understood that the above examples have been simplified for ease of discussion and illustration. In certain instance there may be a plurality of data parameters and environmental parameters, and/or a need for additional data or refinement of the known data. In such instances, the workflow engine may incorporate an optional problem solving system that is operable to take one or more input data elements and provide an optimized solution.

The problem solving system provides a clean and simple interface to a diverse set of algorithms. The problem solving system enables the workflow engine to generically request a problem solution or optimization at runtime without knowledge of the type of algorithm that will be executed in response to the request, or the specific details of the input elements that are generally required for use of one or more appropriate algorithms. In at least one embodiment, the problem solving system is as set forth in U.S. patent application Ser. No. 11/841,073 entitled Problem Solving System and Method, filed on Aug. 20, 2007 and incorporated herein by reference.

In at least one embodiment, the workflow engine 100 is implemented as a computer system for scheduling activities. FIG. 4 is a high level block diagram of an exemplary computer system 400. Computer system 400 has a case 402, enclosing a main board 404. The main board has a system bus 406, connection ports 408, a processing unit, such as Central Processsing Unit (CPU) 410, and a memory storage device, such as main memory 412, hard drive 414, and CD/DVD Rom drive 416.

Memory bus 418 couples main memory 412 to CPU 410. A system bus 406 couples hard drive 414, CD/DVD Rom drive 416, and connection ports 408 to CPU 410. Multiple input devices may be provided, such as for example a mouse 420 and keyboard 422. Multiple output devices may also be provided, such as for example a video monitor 424 and a printer (not shown).

Computer system 400 may be a commercially available system, such as a desktop workstation unit provided by IBM, Dell Computers, Gateway, Apple, Sun Micro Systems, or other computer system provider. Computer system 400 may also be a networked computer system, wherein memory storage components such as hard drive 414, additional CPUs 410 and output devices such as printers are provided by physically separate computer systems commonly tied together in the network. Those skilled in the art will understand and appreciate the physical composition of components and component interconnections comprising computer system 400, and select a computer system 400 suitable for the schedules to be established and maintained.

When computer system 400 is activated, preferably an operating system 426 will load into main memory 412 as part of the boot strap startup sequence and ready the computer system 400 for operation. At the simplest level, and in the most general sense, the tasks of an operating system fall into specific categories—process management, device management (including application and user interface management) and memory management.

In such a computer system 400, the CPU 410 is operable to perform one or more of the scheduling embodiments described above. Those skilled in the art will understand that a computer-readable medium 428 on which is a computer program 430 for adding activities to a schedule may be provided to the computer system 400. The form of the medium 428 and language of the program 430 are understood to be appropriate for computer system 400. Utilizing the memory stores, such as for example one or more hard drives 414 and main system memory 412, the operable CPU 402 will read the instructions provided by the computer program 430 and operate to perform the workflow engine 100 as described above.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed:

1. A workflow engine for managing data, comprising:
a receiving subsystem operable to receive data;
an environment evaluating subsystem operable to evaluate an environment and determine at least one environmental parameter;
a data evaluating subsystem in communication with the receiving subsystem and the environment evaluating subsystem, the data evaluating subsystem operable to;
receive data from the receiving system and determine at least one data parameter;
receive the at least one environmental parameter;
evaluate the data parameter and environmental parameter and determine the selection of at least one appropriate workflow rule; and
establish a workflow job operation for execution by a job operation subsystem.

2. The workflow engine of claim 1, further including a workflow rule pool in communication with the data evaluating subsystem, the evaluating subsystem being operable to provide rule information contained in received data to the rule pool, the rule pool being operable to add and remove a rule during system operation.

3. The workflow engine of claim 1, further including a translator in communication with the receiving subsystem, the translator being operable to receive provided data in an enterprise format and to translate the data into a compliant format for evaluation by the data evaluating subsystem.

4. The workflow engine of claim 1, further including a problem solving optimizer in communication with the evaluating subsystem, the optimizer operable to receive a generic problem request from the evaluating subsystem and to provide an optimized result for determining the at least one appropriate workflow rule.

5. The workflow engine of claim 1, wherein the evaluating system is operable to provide multiple workflow job operations substantially contemporaneously.

6. The workflow engine of claim 1, wherein the workflow engine establishes workflow job operations for a mission management system.

7. A mission management system comprising a workflow engine as in claim 1.

8. A workflow engine for managing data, comprising:
an interface operable to provide connectivity between the workflow engine and an external enterprise;
a translation subsystem coupled to the interface, translation subsystem operable to translate inbound data from an enterprise format to a compliant workflow engine format and to translate outbound data from the compliant workflow engine format to an enterprise format;
an environment evaluating subsystem operable to evaluate an environment and determine at least one environmental parameter;
a workflow rule pool having at least one workflow rule;
a data evaluating subsystem in communication with the translation subsystem, the environment evaluating subsystem and the workflow rule pool, the data evaluating subsystem operable to;
receive data from the interface and determine at least one data parameter;
receive the at least one environmental parameter;
evaluate the data parameter and environmental parameter to determine the selection of at least one appropriate workflow rule from the workflow rule pool; and
establish a workflow job operation for execution by a job operation subsystem.

9. The workflow engine of claim 8, the evaluating subsystem being operable to provide rule information contained in received data to the workflow rule pool, the workflow rule pool being operable to add and remove a rule during system operation.

10. The workflow engine of claim 8, wherein the workflow engine is a portable, enterprise independent mission management system.

11. The workflow engine of claim 8, wherein the translation subsystem includes a plurality of translators, the translation subsystem operable to determine the initial or desired enterprise data format and to select a corresponding translator.

12. The workflow engine of claim 8, wherein the evaluating system is operable to provide multiple workflow job operations substantially contemporaneously.

13. The workflow engine of claim 8, wherein the workflow engine is operable to receive and execute multiple instances of inbound data concurrently.

14. The workflow engine of claim 8, further including a problem solving optimizer in communication with the evaluating subsystem, the optimizer operable to receive a generic problem request from the evaluating subsystem and provide an optimized result for determining the at least one appropriate workflow rule.

15. A method of adaptive mission management, comprising:
receiving data in enterprise format;
translating the received data into a workflow engine format;
sampling the environment to determine at least one environmental parameter
evaluating the translated data to determine at least one data parameter;
evaluating the data parameter and the environmental parameter to identify at least one appropriate workflow rule;
selecting at least one identified workflow rule and developing a workflow job operation with respect to the selected rule, translated data and environmental parameter; and
directing the workflow job operation to a job operation subsystem for execution.

16. The method of claim 15, wherein the translating is performed by a translation subsystem, the environment sampling is performed by an environment evaluating subsystem and the evaluating and selecting is performed by a data evaluating subsystem.

17. The method of claim 15, wherein multiple instantiations of the method may be performed concurrently.

18. The method of claim 15, wherein the method is stored on a computer readable medium as a computer program, which when executed in a computer system will perform the method of mission management.

19. The method of claim 15, wherein the workflow engine format is XML.

20. A computer-readable medium on which is stored a computer program for adaptive mission management, comprising:
an interface routine operatively associated with an input device to provide connectivity between the workflow engine and an external enterprise;
a translation routine operable to receive data from the interface routine and translate inbound data from an enterprise format to a compliant workflow engine format and to translate outbound data from the compliant workflow engine format to an enterprise format;
an environment evaluating routine for evaluating an environment and determine at least one environmental parameter;
a workflow rule pool routine operating to establish a workflow rule pool having at least one workflow rule;
a data evaluating routine in communication with the translation routine, the environment evaluating routine and the workflow rule pool routine, the data evaluating routine operable to;
receive data from the interface routine and determine at least one data parameter;
receive the at least one environmental parameter;
evaluate the data parameter and environmental parameter to determine the selection of at least one appropriate workflow rule from the workflow rule pool; and
establish a workflow job operation for execution by a job operation subsystem.

21. The computer-readable medium of claim 20, the evaluating subsystem being operable to provide rule information contained in received data to the workflow rule pool, the workflow rule pool routine being operable to add and remove a rule during system operation.

22. The computer-readable medium of claim 20, wherein the workflow engine is a portable, enterprise independent mission management system.

23. The computer-readable medium of claim 20, wherein the translation routine includes a plurality of translators, the translation routine operable to determine the initial or desired enterprise data format and to select a corresponding translator.

24. The computer-readable medium of claim 20, wherein the evaluating routine is operable to provide multiple workflow job operations substantially contemporaneously.

25. The computer-readable medium of claim 20, wherein the workflow engine is operable to receive and execute multiple instances of inbound data concurrently.

26. The computer-readable medium of claim 20, further including a problem solving optimizer routine, the optimizer operable to receive a generic problem request from the evaluating routine and provide an optimized result for determining the at least one appropriate workflow rule.
